(19) United States
(12) Patent Application Publication
(10) Pub. No.: US 2026/0031457 A1
(43) Pub. Date: Jan. 29, 2026

(54) ELECTRICAL ENERGY STORAGE ASSEMBLY FOR A VEHICLE

(71) Applicant: AMPERE S.A.S., Boulogne Billancourt (FR)

(72) Inventors: Jonathan DENNERY, Courtaboeuf (FR); Sébastien FURET, Courtaboeuf (FR); Yohann HYRON, Le Mans (FR)

(73) Assignee: AMPERE S.A.S., Boulogne Billancourt (FR)

(21) Appl. No.: 18/996,529

(22) PCT Filed: Mar. 17, 2023
(86) PCT No.: PCT/FR2023/050383

§ 371 Date: Feb. 21, 2025

(30) Foreign Application Priority Data
Jul. 23, 2022 (FR) FR2207584

(51) Int. Cl. H01M 50/242; B60K 1/04; B60L 50/60; B60L 50/64; B60L 58/26; H01M 10/42; H01M 10/613; H01M 10/625; H01M 10/6554; H01M 10/656; H01M 50/204; H01M 50/249; H01M 50/258

(52) U.S. Cl. CPC H01M 50/242; B60K 1/04; B60L 50/64; B60L 50/66; B60L 58/26; H01M 10/425; H01M 10/613; H01M 10/625; H01M 10/6554; H01M 10/656; H01M 50/204; H01M 50/249; H01M 50/258; B60K 2001/0411; B60K 2001/0416; H01M 2220/20

(57) ABSTRACT

An electrical energy storage assembly includes at least two electrical structure elements and at least one cold plate intended to exchange heat energy with at least one electrical structure element. Further, a belt casing and two caps define a cavity to house the electrical structure elements and, at least partially, a cooling structure including two cold plates fixed to respective peripheral edges of the belt casing axially opposite one another. A tier of electrical structure elements is fixed to an internal face of each cold plate and housed in the volume defined by the belt casing. The two tiers of electrical structure elements housed in the belt casing being arranged facing one another with an axial clearance formed between them.

The present invention falls within the field of the electrical energy storage systems, and notably batteries, with which motor vehicles are equipped.

It is known practice nowadays to equip motor vehicles with electrical energy storage members providing electrical power to the various elements of the vehicle and notably motive power. These electrical energy storage members are generally made up of electrochemical electrical energy storage cells arranged in a battery pack.

Motor vehicle manufacturers are now seeking to supply electric or hybrid vehicles that have greater power and greater range autonomy. In order to do that, electrical energy storage assemblies, formed of one or more battery packs that are becoming increasingly bulky, are installed in these electric or hybrid vehicles.

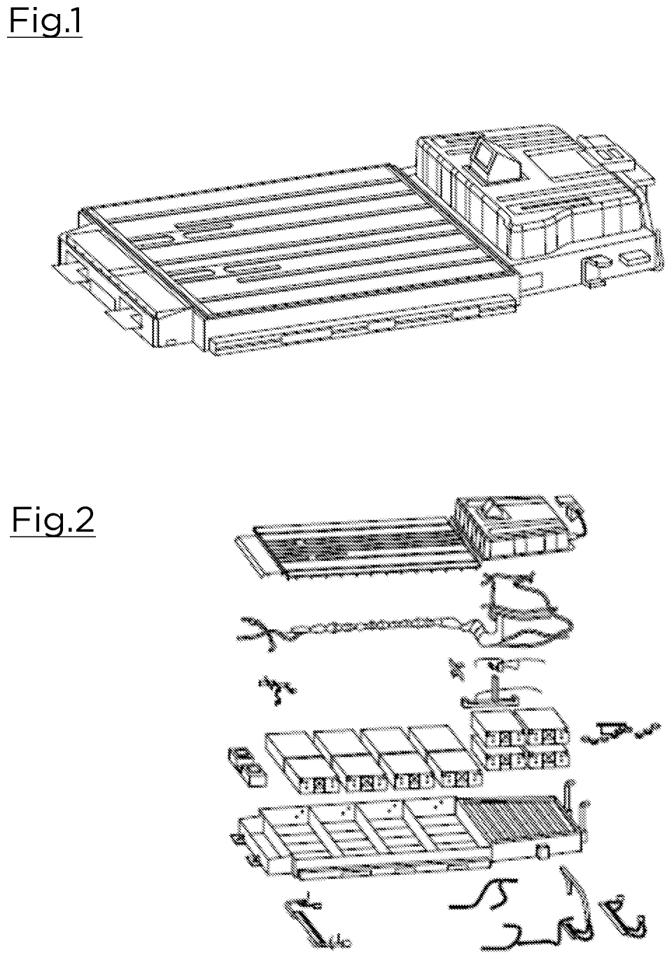

When the manufacturers design a vehicle with an electric or hybrid powertrain, enough space is provided in the vehicle underbody region to howls and electrical energy storage assembly, or battery pack, of conventional design, as illustrated in FIGS. 1 and 2, and which notably comprises a pan configured to house the plurality of battery modules, themselves housing a plurality of electrochemical electrical energy storage cells, and various electrical-connections elements, such as cables or busbars, namely electrical-connections elements that are rigid. The modules are placed in the bottom of the pan, against a bottom wall which may take the form of a cooling floor, which is to say a floor associated with cooling means. A cap is then fixed on the pan to cover the modules and render the assembly fluidtight.

Problems arise when the manufacturers seek to electrify a combustion-engine vehicle, the original dimensions of which were not designed to take such a battery pack. In other words, the volumes available in a combustion-engine vehicle, and more particularly a small sports car, do not allow the reuse of the battery-pan design of battery pack that has just been explained.

The present invention falls within this context and seeks to propose a new design of electrical energy storage system that enables the modules to be arranged in the space more flexibly so as to be able to be made to suited fairy restricted spaces, it being possible for this new designed to be used in order to optimize the use of dedicated space in vehicles with an electric or hybrid powertrain.

In particular, the battery pack, or electrical energy storage assembly, comprises a casing which now takes the form of a surround with no bottom wall and which will be referred to hereinafter as belt casing, instead of the pan shape with a bottom wall as explained in the introduction to the prior art.

The present invention proposes an electrical energy storage assembly for an electric vehicle comprising at least two electrical structure elements including battery modules and/or electronic control components controlling the charging and discharging of the battery modules, a cooling means comprising at least one cold plate, intended to exchange heat energy with at least one electrical structure element, and a cooling circuit configured to supply the cold plate with a heat transfer fluid. According to the invention, a belt casing and two caps define a cavity configured to house the electrical structure elements and, at least partially, the cooling means, the cooling means comprising two cold plates fixed to respective peripheral edges of the belt casing axially opposite one another. Further, each of the cold plates comprises fixing supports for tiers of electrical structure elements, one of the tiers of electrical structure elements being fixed to an internal face of each cold plate and housed in the volume defined by the belt casing, the two tiers of electrical structure elements thus housed in the volume defined by the belt casing being arranged facing one another with an axial clearance formed between them.

The invention relies notably on the electrical structure elements being fixed directly to the cold plates and on the fact that these cold plates are fixed to opposite edges of a belt casing interposed between the cold plates. The two cold plates thus contribute to closing off an internal volume delimited by the belt casing and the two cold plates and within which volume two tiers of electrical structure elements are suspended in the belt casing forming the structure of the electrical energy storage assembly, the electrical structure elements being in contact only with the cold plates thereby enabling a better convective exchange of heat between the cold plate and the electrical structure elements.

Tiers of electrical structure elements should be understood as meaning one or more electrical structure element arranged at the one same level when considering an axial direction perpendicular to the cold plate on which they rest.

The tiers of structure elements are separated from one another by an axial clearance within the belt casing which means that these may be considered to be suspended within the belt casing. This axial clearance should be considered in the aforementioned axial direction, perpendicular to the cold plate on which the electrical structure elements rest. Thus, the height of the belt casing, which is to say the axial dimension of the belt casing extending from one peripheral edge to the other, is defined so as to house to tiers of structure elements, and so as to leave between these an axial clearance that, for reasons concerned with bulkiness, is as small as possible, with the two electrical structure elements being as close together as possible and that is great enough that, on the one hand, the two tiers of structure elements do not knock against one another while the electrical energy storage assembly is being assembled and, on the other hand, the heat released by the electrical structure elements of one of the tiers does not spread to the electrical structure elements of the other of the tiers.

A heat transfer fluid circulates through the cooling means and is configured to remove the heat energy released by the operation of the electrical structure elements and collected by the corresponding cold plate. It should be noted that, without departing from the context of the invention, the heat-transfer fluid could carry heat energy to be released to the electrical structure elements if a pre-heat operation, notably on vehicle start-up, is needed in order to optimize the operation of the electrical structure elements.

According to one feature of the invention, each cold plate comprises a peripheral portion in contact with the peripheral edges of the belt casing, and a central portion comprising said fixing supports for tiers of electrical structure elements.

According to another feature of the invention, each cold plate comprises within it at least one channel configured for heat transfer fluid to pass through it, said at least one channel being connected to the cooling circuit.

In a first embodiment, a cold plate is produced as a single piece, for example as a casting, and the channels are created, for example by piercing, through the material of the cold plate. Each channel in this embodiment extends from one edge face of the cold plate to an opposite edge face.

In a second embodiment, a cold plate is formed by connecting, for example using brazing, two plates of which at least one is pressed, a channel being formed by impressed shapes of the pressing.

According to another feature of the invention, the two cold plates are connected by the cooling circuit which extends outside the belt casing. As mentioned, the cooling means comprises the cold plates and the cooling circuit, and it is notable that none of these elements extends within the belt casing, thereby leaving space available to house the electrical structure elements, and making potential intervention on this cooling means easier. Particularly in the case of a cooling circuit that extends from a canal opening onto an edge face of one cold plate to another canal opening onto an edge face of another cold plate, this simplifies the fitting of the cooling circuit and limits the extent of the circuit.

According to another feature of the invention, two tiers of electrical structure elements are situated one on each side of a cold plate. As mentioned, a tier of electrical structure elements corresponds to one or more electrical structure elements arranged side-by-side on the one same face of the cold plate. The number of structure elements in a tier of electrical structure elements varies according to the type of vehicle to which the electrical energy storage assembly is to be fitted.

According to another feature of the invention, two tiers of electrical structure elements are formed by the electrical structure elements housed in the belt casing and two tiers of electrical structure elements are formed by the electrical structure elements arranged between a cold plate and a cap.

According to another feature of the invention, each tier of electrical structure elements arranged between the cold plate and a cap is arranged in such a way that a space is formed between the electrical structure elements that form this tier and the corresponding cap.

In that way, the electrical structure elements do not touch the caps. To this end, in order to form a space between the cap and the furthest-projecting part of the electrical structure elements, each cap comprises a flat peripheral part able to be in contact with the peripheral portion of the cold plate and a deformed central part, forming a bump, to house the electrical structure elements.

According to another feature of the invention, the tiers of electrical structure elements that are arranged one on each side of the one same cold plate are made up of battery modules. In other words, in this embodiment, one cold plate is used for supporting only battery modules.

According to another feature of the invention, the tiers of electrical structure elements that are arranged one on each side of the one same cold plate comprise a tier of battery modules and a tier of electronic control components controlling the charging and discharging of the battery modules. In other words, in this embodiment, one cold plate is used for supporting both battery modules and electronic components for operating the battery modules present in the electrical energy storage assembly, whether these modules be fixed on the other side of the cold plate or else on other cold plates.

According to another feature of the invention, the belt casing comprises fixing means on each of the axially opposite peripheral edges, said fixing means being configured to allow a cold plate and a cap to be assembled, together, on each of the peripheral edges of the belt casing, with the cold plate clamped between the belt casing and the cap.

By way of example, the belt casing comprises a plurality of bores uniformly distributed along each peripheral edge and each ball is tapped or comprises a tapped insert, the tapping being configured to collaborate with assembly means for assembling the cap on the belt casing, for example fixing screws, which are intended to pass through a cold plate in order to engage in the corresponding bore that forms the fixing means of the belt casing.

According to another feature of the invention, the cold plates comprise holes on their peripheral portion that bears against the peripheral edges of the belt casing, the holes being arranged facing the fixing means of the belt casing so that assembly means for assembling the cap on the belt casing can pass successively through them.

According to another feature of the invention, the electrical structure elements fixed to a cold plate are connected in series by electrical-connection elements.

The electrical-connection elements may for example be busbars, namely rigid connection elements taking the form of a copper strip, fixed to the poles of the battery modules.

According to another feature of the invention, one of the electrical-connection elements connects electrical structure elements which are situated on each side of a cold plate by passing through the cold plate. It will be appreciated that the electrical structure elements arranged on each side of the one same cold plate are connected together in series, like all the electrical structure elements of the one same tier.

According to another feature of the invention, at least one of the electrical-connection elements connected to a battery module fixed on one cold plate extends at least as far as a perforation formed in the other cold plate.

In other words, one of the electrical-connection elements, for example one of the busbars, extends substantially over the entire axial dimension of the belt casing in order to enable tiers of electrical structure elements borne by one cold plate to be connected to the tiers of electrical structure elements borne by the other cold plate, in a context in which the cold plates are fixed to an edge of the belt casing successively, thus preventing access to the inside of the belt casing in order to make the electrical connections. At least one of the cold plates has a perforation providing access to an electrical-connection elements connection zone.

The invention also relates to an electrical supply and storage system for a motor vehicle, wherein at least two electrical energy storage assemblies as described hereinabove are arranged some distance from one another in distinct receiving zones. It should be noted that the distinct receiving zones are arranged at different locations within the vehicle, for example one of them in a front end and the other behind the passenger compartment, and that these receiving zones are distinct in that they do not open into one another.

According to another feature of the invention, the inclination and/or the position of the electrical energy storage assemblies within their respective receiving zone differ from one electrical energy storage assembly to the other. This allows for greater ease of adaptation to suit the volumes available and/or allows the design of a more compact motor vehicle with receiving zones of optimized dimensions, this notably being rendered possible by the structure of the electrical energy storage assemblies having multiple tiers of electrical structure elements that are superposed, held only by the cold plates mounted across a belt casing. The belt casing can just as well be arranged horizontally as vertically, or at a defined inclination, the tiers of electrical structure elements will be suspended from the cold plates within the belt casing in the equivalent way.

The orientation of an electrical energy storage assembly may be defined by the plane of principal elongation of the belt casing, or by the direction of stacking of the electrical structure elements on one another. Whichever of the definitions is chosen for defining the orientation of the two electrical energy storage assemblies, the two electrical energy storage assemblies may have different orientations from one another, notably being substantially perpendicular. Thus, a first energy storage assembly may be in a horizontal position and a second energy storage assembly may be in a vertical position.

According to another feature of the invention, one electrical energy storage assembly is positioned at the front of the vehicle and one electrical energy storage assembly is positioned at the rear of the vehicle, the electrical storage assemblies being connected to one another by a tunnel arranged underneath the passenger compartment and in which a supply circuit and a data circuit are housed.

The connection between the two electrical energy storage assembly is situated at the front and at the rear makes it possible to synchronize operation between the two electrical energy storage assemblies.

The invention also relates to a motor vehicle equipped with two electrical energy storage assemblies, one at the front and one at the rear of the vehicle. Front and rear may be understood as meaning that the two electrical energy storage assemblies are positioned one at each end of the passenger compartment. As mentioned previously, the two volumes in which a respective one of the electrical energy storage assemblies is arranged, may be connected by a cable passing through the tunnel of the vehicle in order to place the batteries in series. Other features and advantages of the invention will become more apparent from the following description, on the one hand, and from a plurality of non-limiting exemplary embodiments that are given by way of indication with reference to the appended schematic drawings, on the other hand, in which drawings:

FIG. 1, already discussed, is a perspective view of a battery pack, or electrical energy storage assembly, according to the prior art,

FIG. 2, already discussed, is a perspective view of the same battery pack according to the prior art, as an exploded view showing the components and notably the pan housing the modules,

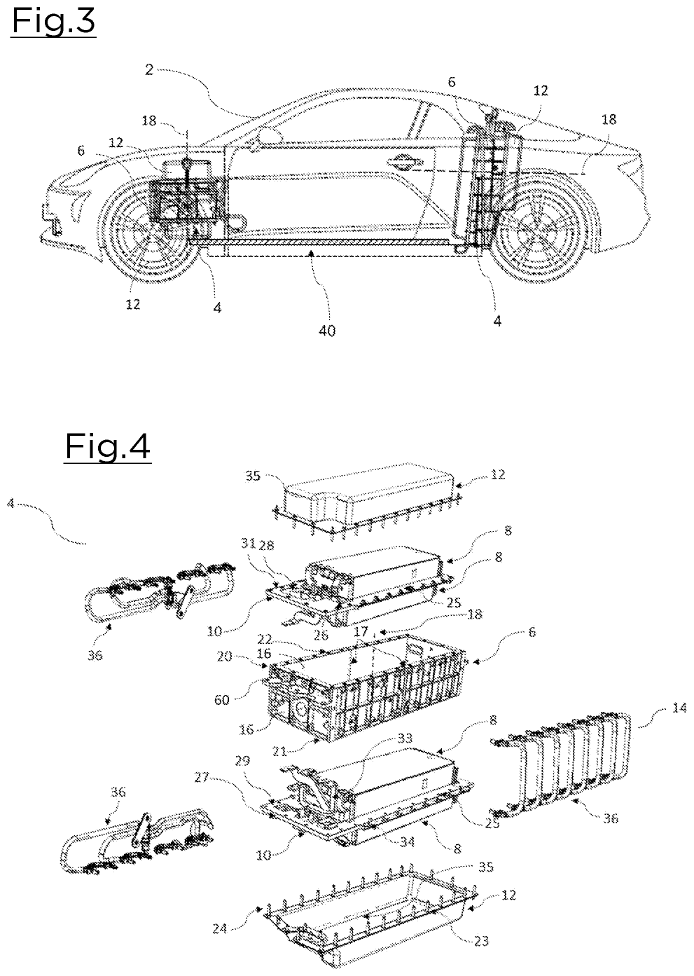

FIG. 3 is a schematic depiction of a motor vehicle equipped with two electrical energy storage assemblies, or battery packs, according to the invention,

FIG. 4 is a perspective depiction, in exploded view, of a first embodiment of an electrical energy storage assembly according to the invention, notably revealing the presence of a belt casing,

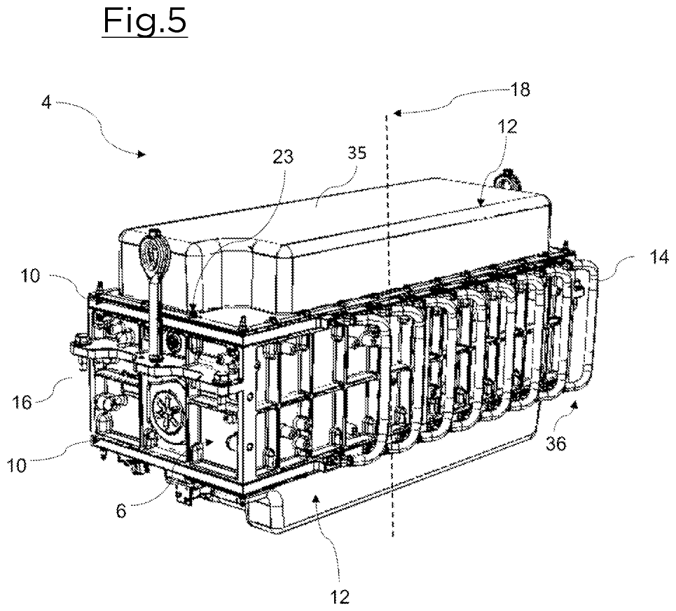

FIG. 5 is a perspective view of an assembled electrical energy storage assembly, according to the first embodiment illustrated in FIG. 4,

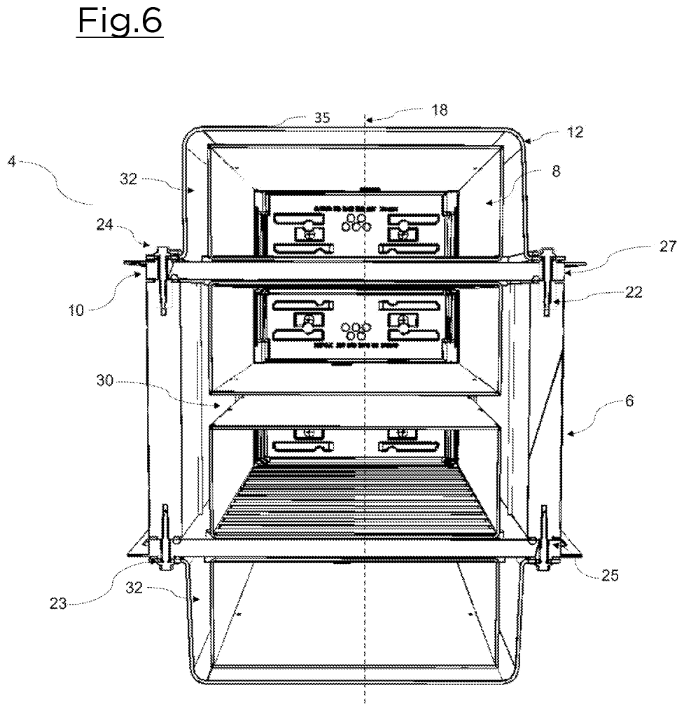

FIG. 6 is a cross-sectional view of an assembled electrical energy storage assembly, according to the first embodiment illustrated in FIGS. 4 and 5,

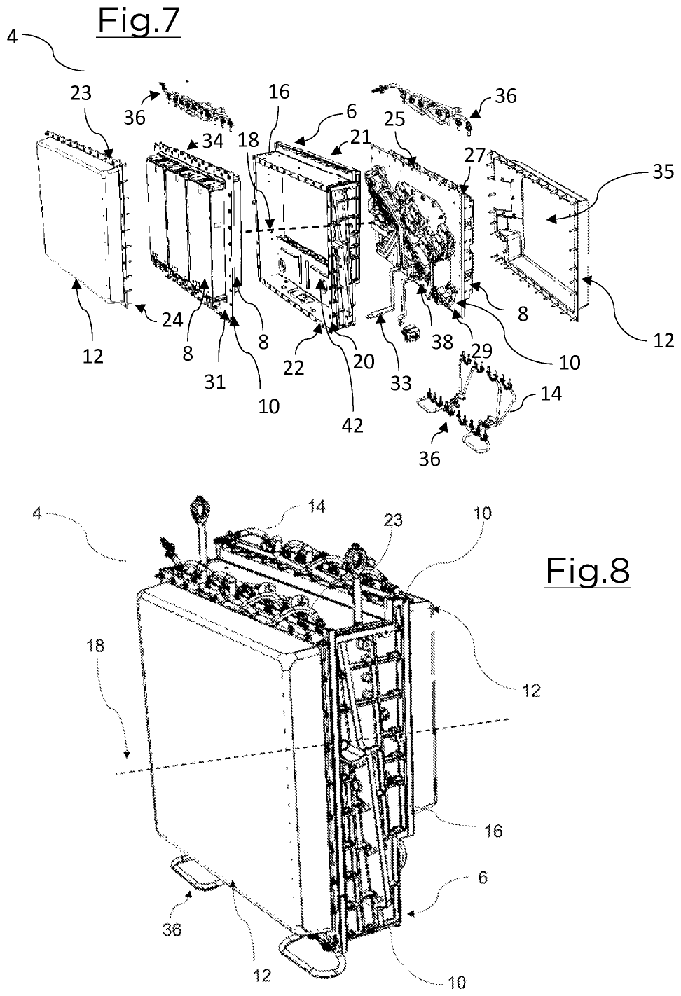

FIG. 7 is a perspective depiction, in exploded view, of a second embodiment of an electrical energy storage assembly according to the invention,

FIG. 8 is a perspective view of the assembled electrical energy storage assembly, according to the second embodiment illustrated in FIG. 7,

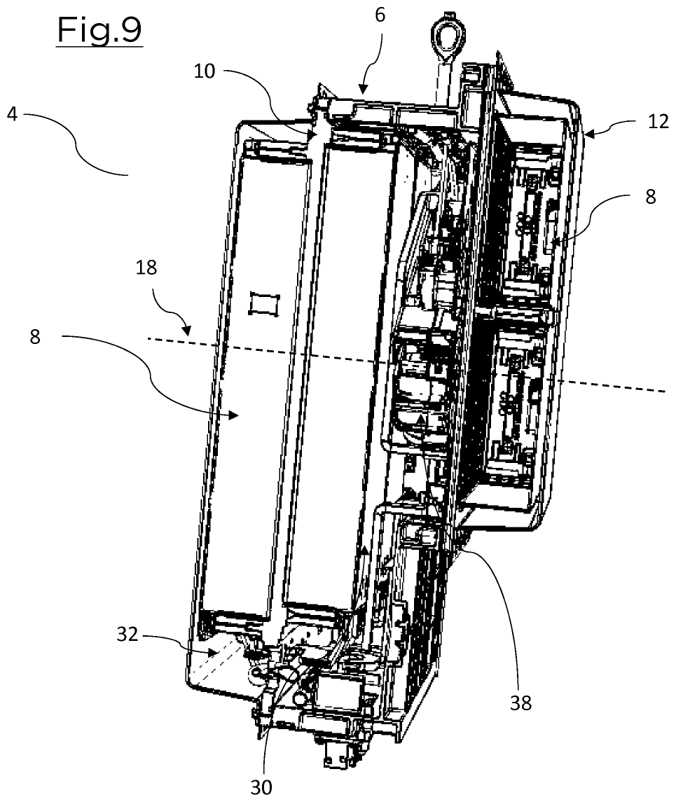

FIG. 9 is a cross-sectional view of the assembled electrical energy storage assembly, according to the second embodiment illustrated in FIGS. 7 and 8.

The features, variants and various embodiments of the invention may be combined with one another, in various combinations, as long as they are not mutually incompatible or mutually exclusive. It will be possible, in particular, to imagine variants of the invention that comprise only a selection of features described below, in a manner isolated from the other features described, if this selection of features is sufficient to provide a technical advantage and/or to differentiate the invention from the prior art.

Remember that the invention relates to a novel electrical energy storage assembly that is easier to integrate into an electric vehicle or a vehicle that is to be electrified, by enabling optimization of the overall bulk and/or an orientation suitable for integration into a specific receiving zone. The electrical energy storage assembly according to the invention thus comprises two tiers of electrical structure elements which are arranged suspended within a belt casing, each battery module being fixed to a cold plate which rests on a peripheral edge of the belt casing.

FIG. 3 illustrates a motor vehicle 2 equipped with two electrical energy storage assemblies 4 conforming to that which has just been explained and which together form an electrical supply and storage system.

In the example illustrated, without this implying limitation on the invention, the motor vehicle 2 comprises two volumes available for the electrical energy storage assemblies 4, one at the front and one at the rear.

The two volumes may be connected by one or more cables passing through a tunnel 40 arranged beneath the passenger compartment of the vehicle so that the electrical energy storage assemblies 4 positioned in a respective one of these volumes can be connected in series with one another, the cable or cables having the function of transmitting current and/or operating instructions from one electrical energy storage assembly 4 to the other.

As will be described in greater detail hereinafter, each electrical energy storage assembly 4 comprises a belt casing 6 and caps 12 arranged one on each side of the belt casing 6 and which together define a cavity within which are housed electrical structure elements fixed to cold plates interposed between the belt casing and a respective one of the caps.

In each electrical energy storage assembly 4, the belt casing 6 has the form of a cylinder about an axis of elongation 18, and the belt casing 6 may thus be defined as having a height extending along the axis of elongation 18. The cold plates which are interposed between the belt casing and a respective one of the caps 12, extends substantially perpendicular to the corresponding axis of elongation, as is notably visible in FIG. 4.

The two electrical energy storage assemblies 4 present on the vehicle are in this instance arranged with different orientations, this being notably made possible by the configuration of each assembly, having a belt casing 6 as will be described in detail hereinafter. The electrical energy storage assemblies 4 have different orientations from one another in so far as the axes of elongation 18 as already defined are secant. More particularly, in the example illustrated, the electrical energy storage assemblies 4 are arranged in orientations that are substantially mutually perpendicular.

The electrical energy storage assembly 4 present at the front of the vehicle is arranged horizontally, namely with an axis of elongation that is substantially vertical, and cold plates bearing electrical structure elements 8, 38 that extend principally along a plane parallel or substantially parallel to the floor of the vehicle 2. The electrical energy storage assembly 4 present at the rear of the vehicle is, for its part, arranged vertically, namely with an axis of elongation that is substantially horizontal, and cold plates bearing electrical structure elements 8, 38 that extend principally along a plane perpendicular or substantially perpendicular to the floor of the vehicle 2.

The electrical energy storage assembly 4 front may thus be arranged in a space having a small height, and the electrical energy storage assembly 4 here may thus be arranged in a space that is fairly narrow but tall, for example behind a row of seats between the passenger compartment and the luggage compartment.

FIGS. 4, 5 and 6 illustrate a first embodiment of an electrical energy storage assembly 4 according to the invention. In this instance this is the electrical energy storage assembly 4 arranged at the front of the vehicle in the example illustrated in FIG. 3.

The electrical energy storage assembly 4 notably comprises, as already mentioned, a belt casing 6, electrical structure elements 8 at least one of which is suspended within the belt casing 6, two cold plates 10, two caps 12, and it also comprises a cooling circuit 14.

The belt casing 6 comprises four lateral walls 16 defining a cross section that in this instance is rectangular. The belt casing 6 is in the form of a cylinder, of rectangular cross section, such that the axis of elongation 18 of the electrical energy storage assembly 4 is parallel to each of the lateral walls 16 of the belt casing 6. The axis of elongation 18 passes through the center of the rectangular cross section of the belt casing 6. The belt casing 6 is open-ended, with no wall perpendicular to the axis of elongation 18 and covering the lateral walls 16, having the form of a surround the height of which is defined by the axial dimension of the lateral walls 16 between two opposite end edges.

The belt casing 6 has two axially opposite peripheral edges 20, 21. First end edges of the lateral walls 16 a form a first peripheral edge 20 of the belt casing 6, and second end edges of the lateral walls, which are opposite edges along the axis of elongation 18, form a second peripheral edge 21 of the belt casing 6.

The belt casing 6 may be produced in different ways, without departing from the context of the invention, provided that it has a shape that is open at each axial end and therefore peripheral edges to which the cold plates may be fixed. In the example illustrated, the belt casing 6 is formed of two half-cases that are welded together, along a parting-line plane 17 which in this instance is parallel to the axis of elongation 18 of the belt casing 6. Alternatively, the belt casing 6 is produced as a single piece.

The belt casing 6 comprises a plurality of bores 22 extending axially into the material of the belt casing 6, from the peripheral edges 20, 21 thereof. These bores 22 are evenly distributed along the entire periphery of the belt casing. The bores 22 contribute to forming the fixing means that are configured to allow a cold plate 10 and a cap 12 to be assembled, together, on each of the peripheral edges 20, 21 of the belt casing 6. To this end, the fixing means may consist of a tapping of each bore or else of a tapped insert fitted inside each bore, the tapping being intended to collaborate with a assembly means for assembling the cap on the casing and that will be described hereinafter.

The electrical structure elements 8 are distributed across a plurality of tiers in the electrical energy storage assembly 4, a tier of electrical structure element 8 being formed from one or more electrical structure elements 8 arranged on the one same side of a cold plate 10. In the example illustrated, four tiers of electrical structural elements 8 are comprised in the electrical energy storage assembly 4, with a first tier of electrical structure elements 8 arranged on a first side of a first cold plate 10, a second tier of electrical structure elements 8 arranged on a second side of this first cold plate 10, a first tier of electrical structure elements 8 arranged on a first side of a second cold plate 10 and a fourth tier of electrical structure elements 8 arranged on the second side of this second cold plate 10. Each electrical structure element 8 is fixed, for example by screw-fastening, to a cold plate, a fixing face of each electrical structure element 8 being in contact with the cold plate 10.

In other words, in the example illustrated, each cold plate 10 comprises fixing supports on each of its faces so as to allow one or more electrical structure elements 8 to be fixed on each side of the cold plate 10.

According to the invention, the cold plates 10 are fixed on the peripheral edges 20, 21 of the belt casing, so that two of the tiers of electrical structure elements 8, in this instance the second tier and the third tier, are housed in the belt casing 6, and as close to one another as possible in order to reduce the axial bulk of the electrical energy storage assembly. The height of the belt casing 6 is defined in such a way as to house the two tiers of electrical structure elements 8 within the belt casing 6 with one face of each tier of electrical structure elements 8 facing, and as close as possible to, the other, while ensuring that there is an axial clearance, along the axis of elongation 18 defined earlier, between the tiers of electrical structure elements 8.

FIG. 6 shows the axial clearance 30 between the tiers of electrical structure elements 8 in the belt casing 6. The magnitude of the axial clearance 30 may be comprised between 10 and 50 mm. The axial clearance 30 is small enough that the bulk of the electrical energy storage assemblies 4 can be reduced as far as possible. Moreover, the axial clearance 30 may make it possible to ensure that the two tiers of electrical structure elements 8 within the belt casing 6 do not touch one another. The tiers of electrical structural elements 8 comprised in the belt casing 6 do not touch, in order to allow the electrical structure elements 8 to be fitted and in order to avoid noise caused by the vibrations generated by the vehicle 2 when in use.

Each electrical structure element 8 has a fixing face, forming a base facing the cold plate against which it rests, and a top face, on the opposite side from the fixing face. Within the one same tier of electrical structure elements, all the electrical structure elements 8 are oriented in the same way with the fixing face against the cold plate. On each side of the one same cold plate 10, the electrical structure elements 8 are positioned in opposite directions, with the electrical structure elements 8 arranged on one side of the cold plate having their fixing face in one direction when considering the axial direction 18, and the electrical structure elements 8 arranged on the other side of the same cold plate having their fixing face in the opposite direction. The same is true of the electrical structure elements arranged on the cold plates and housed within the belt casing, with their top face facing one another. The result of this is that the orientation of the electrical structure elements 8 may be in one direction or the other with respect to the axial direction 18 depending on which side of the cold plate they are fixed to, and there is therefore no longer any need to ensure that they are positioned as in the prior art with the top face forming an uppermost face arranged above the fixing face that forms the lowermost face.

As has been mentioned, the cold plates 10 are arranged between the caps 12 and the belt casing 6, one on each side thereof. The cold plates 10 each comprise a peripheral portion, formed around the entire periphery of a cold plate and intended to be in contact with the peripheral edges of the belt casing, and a central portion which comprises the fixing supports previously mentioned for fixing the tiers of electrical structure elements. In FIG. 4, electrical structure elements are fixed to each cold plate which means that the central portion is not visible because it is covered.

The peripheral portion of each cold plate may thus be defined as being the portion extending from an edge face 27 transversely delimiting the cold plate 10 as far as the electrical structure elements 8 fixed to the cold plate. A first face 29 of the peripheral portion of a cold plate faces toward the belt casing so as to be in contact with the first peripheral edge 20 or the second peripheral edge 21 of the belt casing and a second face 31 of the peripheral portion, which is the opposite face from the first face 29, faces toward the corresponding cap 12.

The cold plates 10 comprise channels 34 which allow a heat transfer fluid to circulate within the cold plates. In the example illustrated, the channels are produced transversely within the material of the cold plates, from one edge face 27 to an opposite edge face. The channels 34 may be obtained by means of bores made transversely in the material or by the presence of appropriate sliding cores during the injection-molding operation. The material between these channels 34 and the tiers of the battery modules 8 corresponds to the surface for the exchange of heat between the tiers of battery modules 8 and the heat-transfer fluid circulating in these channels 34.

Each cold plate 10 is positioned on the belt casing 6 by bringing the peripheral portion of the cold plate 10 and one of the peripheral edges 20, 21 of the belt casing 6 into contact with one another and axially aligning the holes 25 arranged in the peripheral portion of the cold plate 10 with the bores 22 formed in the peripheral edge against which said cold plate is resting. The cold plate 10 is then fixed to the belt casing by employing the fixing means of the belt casing and complementing assembly means. In the example illustrated, the cap is involved in the fixing of the cold plate to the belt casing, using the same assembly means and the same fixing means.

Thus, the belt casing 6 and its rectangular cross section, with no wall arranged across its lateral walls, is a housing for the electrical structure elements 8 and also a mounting support for the caps 12 and the cold plates 10 of the electrical energy storage assembly 4, the belt casing furthermore comprising fixing lugs 60 for mounting the electrical energy storage assembly on the vehicle body.

The electrical energy storage assembly 4 is closed on each side of the belt casing 6 by the two caps 12. Each cap 12 is secured to the belt casing 6, clamping the peripheral portion of a cold plate between this cap and a peripheral edge 20, 21 of the belt casing 6, as visible in FIG. 5. More particularly, in the example illustrated, each cap comprises a flat peripheral part which is arranged against the second face 31 of the peripheral portion of a cold plate. Assembly means 24, in this instance threaded shanks, that are mounted passing through this flat peripheral part of the cap 12, become lodged in the holes 25 formed on the cold plate 10 and in the bores 22 present on the peripheral edge 20, 21 of the belt casing 6, and engage with the tappings in order simultaneously to fix one cap and one cold plate to the belt casing. The cold plate 10 is thus mounted clamped between the cap 12 and the belt casing 6.

In the example illustrated, the caps 12 have the same dimensions and shapes, but it should be noted that, without departing from the context of the invention, the caps 12 may, within the one same electrical energy storage assembly 4, adopt differing shapes, notably according to the number of tiers of electrical structure elements present.

Thus, in the first embodiment illustrated, the caps 12 have a central part 35 projecting from the flat peripheral part, giving the caps 12 a dished shape and dimensioned to house a tier of electrical structure elements arranged on a cold plate on the opposite side from the belt casing.

A space 32 may be seen between the caps 12 and the tiers of electrical structure elements 8 that are housed therein, and this space is similar to the axial clearance 30 comprised between the tiers of electrical structure elements 8 comprised in the belt casing 6. In that way, the electrical structure elements 8 present in the electrical storage assembly 4 according to the invention are all suspended, in so far as they are in contact only with one face of a cold plate which, for its part, is fixed only in an overhanging manner between the belt casing and a cap, and in so far as these electrical structure elements 8 do not touch any other component of the electrical storage assembly 4.

In a variant of the preceding embodiment, the electrical energy storage assembly 4 comprises only two tiers of electrical structure elements 8 which are fixed on a respective cold plate so as to extend within the belt casing 6 such that there is no electrical structure element present between a cap and a cold plate. In that scenario, a cap 12 may have a substantially flat shape, in one same plane or substantially in the one same plane as the plane in which the peripheral part of the cap extends.

In the first embodiment presented in FIGS. 4, 5 and 6, the tiers of electrical structure elements 8, 38 that are arranged one on each side of the one same cold plate are made up of battery modules 8 and solely of battery modules.

The battery modules 8 are connected to one another in such a way as that a supply of electricity can be passed in series through each battery module in succession and in such a way that the battery modules are arranged on the one side or on the other side of a cold plate 10. The battery modules of the one same tier of battery modules 8 are connected to one another, and a battery module of a first tier of battery modules 8 is connected to a battery module of another tier of battery modules. These series connections of the battery modules 8 are made using electrical-connection elements 33, the electrical-connection elements 33 potentially being, for example, busbars.

As visible in FIG. 4, each cold plate 10 comprises one or more passages 26 passing axially through the cold plate so as to allow the passage of a busbar used for the electrical interconnection of the battery modules 8 arranged on each side of this cold plate. Further, at least one of the cold plates moreover comprises a perforation 28, likewise passing right through it, which is sized to allow tooling needed for assembling the various busbars to electrical components of the relay type to pass through it. The perforations and the passages 26 are covered by the caps 12 at the end of the assembly of the electrical energy storage assembly 4.

Moreover, as mentioned previously, the electrical energy storage assembly 4 comprises a cooling circuit 14 which, in this instance, comprises circulation pipes 36 for the heat transfer fluid. The circulation pipes 36 are connected to the channels 34 of the cold plate 10 by that part of the channels 34 that opens onto the edge face 27 of the cold plate 10. This part of the channels is accessible as the edge face is interposed between the belt casing 6 and one of the caps 12. These heat transfer fluid circulation pipes 36 span between the two cold plates 10 on the outside of the belt casing 6. All the channels 34 of the cold plates 10 are connected to one another.

FIGS. 7, 8 and 9 illustrate a second embodiment of an electrical energy storage assembly 4 according to the invention. In this instance this is the electrical energy storage assembly 4 arranged at the rear of the vehicle 2 in the example illustrated in FIG. 3.

In accordance with that which may have been described in respect of the first embodiment, the electrical energy storage is assembly 4 notably comprises a belt casing 6, a plurality of tiers of electrical structure elements 8, 38, two cold plates 10, two caps 12, and a cooling circuit 14.

In this second embodiment, the electrical structure elements comprise, in addition to the battery modules, components 38 necessary for the use of the electrical energy storage assembly 4 and, more particularly, electronic control components 38 controlling the charging and discharging of the battery modules 8. The shape of the belt casing 6 is therefore adapted to suit the presence of these particular components 38 in the electrical energy storage assembly 4.

More particularly here, FIG. 7 shows a first cold plate 10 with two tiers of battery modules 8 screwed one onto each side of this cold plate 10. Also visible is a second cold plate 10 with one tier of battery modules and the components 38 screwed one onto each side of this cold plate 10.

The components 38 may notably comprise a control system controlling the charging and discharging of each of the battery modules 8 of the electrical energy storage assembly 4. In the embodiment of the vehicle 2 equipped with two electrical energy storage assemblies 4, the components 38 in contact with the second cold plate 10 of one of the electrical energy storage assemblies 4 are able to synchronize the two electrical energy storage assemblies 4 and to regulate the charging and discharging thereof. To this end, as shown in FIG. 3, and as mentioned previously, the electrical energy storage assemblies 4 are connected to one another via a tunnel 40 passing along the vehicle 2, underneath the passenger compartment, this tunnel comprising a supply circuit and a data circuit.

In accordance with that which was described previously, the electrical energy storage assembly is assembled in such a way that each cord plate is clamped between the belt casing and a cap, with one tier of electrical structure elements arranged on each side of the cold plate so that two tiers of electrical structure elements are housed in the volume defined by the belt casing with an axial spacing between them. In this embodiment, it is one of the tiers of battery modules 8 and the tier of components 38 that are housed within the belt casing between the two cold plates.

It should be noted that, alternatively, without departing from the context of the invention, the components 38 may be positioned on one face of a cold plate between this plate and a cap, so that it is two tiers of battery modules 8 that are housed within the belt casing.

FIG. 7 reveals the fact that the belt casing 8 may within it comprise a blanking wall 42 which extends partially across the opening, from one lateral wall 16 to an opposite lateral wall. This blanking wall 42 is dimensioned to leave an opening so that the components 38 secured to a cold plate 10 can be positioned within the belt casing. The opening is dimensioned so that the components 38 can be housed in the belt casing 6 but without the components 38 touching anything other than the cold plate 10.

As has just been described, the invention does indeed achieve its stated objectives by proposing an electrical energy storage assembly that is particularly compact, having electrical structure elements superposed with one another without any support structure interposed between them, so as to be able to ensure that an optimized, and notably the smallest possible, axial separation is formed between the electrical structure elements that are superposed within the belt casing.

Naturally the invention is not restricted to the examples that have just been described, and numerous adaptations may be made to these examples without departing from the scope of the invention, provided that the electrical structure elements are suspended facing one another within the belt casing, being fixed to a respective cold plate arranged at one end of the belt casing.

1-15. (canceled)

16. An electrical energy storage assembly for an electric vehicle, comprising:
at least two electrical structure elements including battery modules and/or electronic control components to control charging and discharging of the battery modules;
cooling means comprising at least two cold plates to exchange heat energy with at least one electrical structure element and a cooling circuit configured to supply the cold plates with a heat transfer fluid;
a belt casing and two caps that define a cavity configured to house the electrical structure elements and, at least partially, the cooling means,
wherein the two cold plates are fixed to respective peripheral edges of the belt casing axially opposite one another, each of the cold plates comprising fixing supports for tiers of the electrical structure elements, one of the tiers of electrical structure elements being fixed to an internal face of each cold plate and housed in a volume defined by the belt casing, the two tiers of electrical structure elements thus housed in the volume defined by the belt casing being arranged facing one another with an axial clearance formed between them.

17. The electrical energy storage assembly as claimed in claim 16, wherein each of the cold plates comprises at least one channel configured for heat transfer fluid to pass through said at least one channel, said at least one channel being connected to the cooling circuit.

18. The electrical energy storage assembly as claimed in claim 16, wherein the two cold plates are connected by the cooling circuit which extends outside the belt casing.

19. The electrical energy storage assembly as claimed in claim 16, wherein the two tiers of electrical structure elements are situated one on each side of one of the cold plates.

20. The electrical energy storage assembly as claimed in claim 19, wherein the two tiers of electrical structure elements are formed by the electrical structure elements housed in the belt casing and the two tiers of electrical structure elements are formed by the electrical structure elements arranged between one of the cold plates and one of the caps.

21. The electrical energy storage assembly as claimed in claim 19, wherein the tiers of electrical structure elements that are arranged one on each side of one of the cold plates are made up of battery modules.

22. The electrical energy storage assembly as claimed in claim 19, wherein the tiers of electrical structure elements that are arranged one on each side of one of the cold plates comprise a tier of battery modules and a tier of the electronic control components controlling the charging and discharging of the battery modules.

23. The electrical energy storage assembly as claimed in claim 16, wherein the belt casing comprises fixing means on each of the peripheral edges, said fixing means being configured to allow one of the cold plates and one of the caps to be assembled, together, on each of the peripheral edges of the belt casing.

24. The electrical energy storage assembly as claimed in claim 23, wherein the cold plates comprise holes on a peripheral portion that bears against the peripheral edges of the belt casing, the holes being arranged facing the fixing means of the belt casing so that assembly means for assembling the cap on the belt casing can pass successively through them.

25. The electrical energy storage assembly as claimed in claim 16, wherein the electrical structure elements fixed to one of the cold plates are connected in series by electrical-connection elements.

26. The electrical energy storage assembly as claimed in claim 25, wherein one of the electrical-connection elements connects battery modules which are situated on each side of one of the cold plates by passing through the one of the cold plates.

27. The electrical energy storage assembly as claimed in claim 26, wherein at least one of the electrical-connection elements connected to the battery module fixed on one of the cold plates extends at least as far as a perforation formed in the other cold plate.

28. An electrical supply and storage system for a motor vehicle, comprising:
at least two of the electrical energy storage assemblies as claimed in claim 16, the at least two of the electrical energy storage assemblies being arranged some distance from one another in distinct receiving zones.

29. The electrical supply and storage system as claimed in claim 28, wherein an inclination and a position of the electrical storage assemblies may differ from one of the storage assemblies to the other.

30. The electrical supply and storage system as claimed in claim 28, wherein the electrical storage assemblies are connected to one another by a tunnel arranged underneath a passenger compartment of the motor vehicle and in which a supply circuit and a data circuit are housed.
